(19) United States
(12) Patent Application Publication
(10) Pub. No.: US 2013/0133709 A1
(43) Pub. Date: May 30, 2013

(54) Fluid Flushing Apparatus

(71) Applicant: Maurice William Davis, Marie, MI (US)

(72) Inventor: Maurice William Davis, Marie, MI (US)

(21) Appl. No.: 13/308,352

(22) Filed: Nov. 30, 2011

(51) Int. Cl. B08B 9/032

(52) U.S. Cl. 134/166 C

(57) ABSTRACT

A fluid flushing apparatus for a fluid line with a fluid bearing debris, the apparatus includes an outer surrounding sidewall having an external surface and an interior surface defining a first interior, the outer sidewall having an inlet end with a first check valve and flange end, with the inlet end attached to a fluid line inlet. Also, an inner surrounding sidewall with an outside surface and an inside surface that defines a first void, also with a primary end and a secondary end with a second check valve attached to the fluid line outlet. The outside surface is a slip fit with the interior surface, wherein the inner sidewall is disposed within a portion of the first interior. Operationally, the inlet and the secondary ends are drawn apart and then pushed together, thereby moving the fluid and debris from the inlet to the outlet of the fluid line.

### TECHNICAL FIELD

The present invention generally relates to fluid flushing/dispensing apparatus and more particularly to a portable manually operated fluid mover for the selective application of a specific fluid to a fluid communication system.

### BACKGROUND OF INVENTION

There are a variety of fluid dispensers in the prior art. Fluid dispenser components typically comprise: a reservoir, a means for regulating fluid flow, and a connector. The reservoir contains a fluid and also has a means for motivating the fluid to communicate into the means for regulating the fluid flow and further communicating to the connector. The means for motivating the fluid out of the reservoir can be anything from simply using gravity to having a means for increasing the pressure of the fluid in the reservoir thus motivating the fluid to flow out of the reservoir through the means for regulating the fluid flow and onward to the connector. The means for motivating the fluid out of the reservoir outside of simply using gravity can include using a movable piston inside of a close fitting bore such as in a typical hypodermic needle, or having a reservoir constructed of a resilient material wherein the reservoir is compressed in some manner to reduce its interior volume thus raising the pressure of the fluid in the reservoir, such as in a peristaltic pump. The means for regulating the fluid flow can include simply having a selectively sized fluid flow passageway, or a valve of some type. The connector portion of the fluid dispenser can include a hollow needle being a cannula with a lumen, a luer connector, a screw connector, a barbed connector, and the like.

There are many issues surrounding the fluid dispenser, such as accurate controlling of the measured volumes of the fluid dispensed, how to handle the many different types of fluids and their properties, such as viscosity, miscibility of the various fluid components, and the drying or hardening characteristics of the fluid as it flows through the connector and into the desired fluid communication system. Other issues for fluid dispensers would include fluid waste, spillage, leakage, and reuse of the fluid dispenser after a period of inactivity wherein the fluid may dry or harden in or on any of the fluid dispenser components. In addition, reservoir breakage and accidental discharge of the fluid can be problems while the fluid dispenser is in use.

In addressing the above-identified issues that are common to fluid dispensers, the prior art discloses a number of different types of apparatus. Starting with the accurate controlling of the measured volume of fluid to be dispensed, a common solution is to utilize a movable piston in a close fitting bore while closely controlling the axial movement of the piston with graduations marked on the outside of a translucent of clear bore, thus controlling the axial displacement or volume reduction in the reservoir as is common with a hypodermic needle assembly. Another method of controlling the volume of the fluid to be dispensed is to simply size the reservoir volumetrically to contain the desired volume of fluid to be dispensed, which would make the reservoir a single use system that may be disposable if it is not refillable, such as with a common eyedropper assembly.

Looking in the prior art starting with U.S. Pat. No. 4,834,714 to Lascar, et al. disclosed a double compartment syringe. The first compartment in Lascar is bounded by a first cylinder, closed off at one end by a first partition in which an opening is provided, and at its other end by a first sliding piston. This syringe in Lascar also contains a second cylinder coaxial to and inside of the first cylinder, attached at its first extremity to the first piston and closed off at its second extremity by a second partition, and an axial rod , coaxial to and inside of the second cylinder, that is attached to the first partition by its first extremity, sliding across the first piston and supporting at its other extremity a second piston that slides into the second cylinder. In this manner Lascar has a second compartment is formed by the second cylinder, the second piston, and the second partition, the volumes contained in the two compartments fluctuating simultaneously when the second cylinder is shifted in relation to the first one. In essence Lascar et al., provides for multiple syringes in one, being particularly useful for field work, however, there is no teaching of check valves in conjunction with the syringe. Lascar has a main function in doing injections that control multiple medicine mixtures and multiple injection metering,

Continuing, in the applicable prior art, in U.S. Pat. No. 5,171,220 to Morimoto, disclosed is a disposable syringe of a dual-chamber type, wherein an injection needle is secured to the tip end of an injection cylinder with a first component being filled in it. The injection cylinder in Morimoto is accommodated for its free sliding operation within a cylindrical housing, a second component container is air tightly secured to the tip end of the housing through a seal member through which a penetrating operation can be effected. Also, there is a cover in Morimoto for air tightly covering the injection cylinder rear end portion, including a plunger which is inserted for its free sliding operation into the injection cylinder in cooperation with the housing which is engaged with the rear end of the housing, again note that, there is no teaching of check valves in conjunction with the syringe. Essentially the main function in Morimoto is to mix two different medicines together at syringe injection that are previously kept separated.

Further, in the prior art in U.S. Pat. No. 7,311,692 to Kato, et al. disclosed is yet another dual-chamber type prefilled syringe comprising: a cylindrical body which has a first end provided with a portion for attaching an injection needle. Kato has a front plug member, a middle plug member, and an end plug member being hermetically fitted within the cylindrical body in the mentioned order from the first end of the cylindrical body, the front plug member and the middle plug member having rear ends, respectively, on a side away from said first end; a first chamber being formed between the front plug member and the middle plug member within the cylindrical body and accommodating a first component. Further, in Kato there is a second chamber being formed between the middle plug member and the end plug member within the cylindrical body and accommodating a second component; and a bypass formed on an inner surface of the cylindrical body in the shape of a concave groove, the bypass being longer than the middle plug member along an axial direction of the cylindrical body and having a rear end portion on a side away from the first end. Wherein the first chamber in Kato communicates with the second chamber via the bypass when the middle plug member moves toward the first end to reach a position where the bypass is formed; and wherein an inner volume of the cylindrical body between the first end of the cylindrical body and the rear end of the front plug member occurs when the rear end of the middle plug member has reached the rear end portion of the bypass, being at least 60% of a volume of the second component and not more than the volume of said second component. Wherein Kato et al., is a controlled multiple medication mixing syringe by volume control, there is no teaching of check valves in conjunction with the syringe.

Next, in the prior art in U.S. Pat. No. 5,496,284 to Waldenburg disclosed is another dual-chamber syringe that has a plunger within an inner delivery chamber in fluid communication with an ejection port. The delivery chamber in Waldenburg is formed within a tubular element is axially slidable within a tubular guide, wherein the tubular guide and the syringe outer barrel form an outer reservoir chamber. The outer reservoir chamber in Waldenburg is sealed from the delivery chamber while the tubular element is in a first position within the guide. Upon withdrawal of the plunger in Waldenburg, frictional contact imparted by the plunger seal causes the tubular element to slide away from sealing engagement with the barrel into a second position within the guide. In Waldenburg, with the second position of the tubular element, a fluid passageway is opened from the reservoir to the delivery chamber allowing fluid to be drawn into the delivery chamber from the storage reservoir. A porous seal in Waldenburg between the plunger rod and barrel allows air into the reservoir during transfer of fluid to the delivery chamber and pressing the plunger inward first moves the tubular element from the second position back to the first position to close the fluid passageway, and then expels fluid from the delivery chamber through the ejection port. Thus functionally, Waldenburg allows for multiple metered injections with a single needle insertion, in rapid sequence using a single syringe, note also again, there is no teaching of check valves in conjunction with the syringe.

Continuing in the prior art in U.S. Pat. No. 5,429,610 to Vaillancourt disclosed is a dual chamber syringe is employed for collecting blood samples. The syringe in Vaillancourt includes a plunger which is connected to a first piston which, in turn, is connected via a flexible string element to a second piston. A passageway in Vaillancourt is formed in the wall of the syringe barrel to communicate the duct at the forward end of the barrel with the chamber between the two pistons. Thus in Vaillancourt, upon withdrawal of the plunger from a barrel, fluid flows into the chamber created between the two pistons. In Vaillancourt subsequent movement of the two pistons in unison causes a whole blood sample to be drawn into the foremost chamber within the barrel. The syringe in Vaillancourt can be subsequently connected with a vacutainer via a needle assembly so as to discharge the whole blood sample into the vacutainer for subsequent testing procedures. The discard fluid in Vaillancourt can be separately dispensed into another container. Further in Vaillancourt a catch is employed on the syringe barrel or on the plunger to positively prevent a movement of the plunger into the barrel which would cause a discharge of the discard fluid. Again, in Vaillancourt there is no teaching of check valves in conjunction with the syringe.

What is needed is a fluid dispenser that overcomes the previously identified issues related to fluid dispensers, being selectable volumes of fluid to dispense from the reservoir, the means of controlling or regulating the fluid flow, the method of applying the fluid to the connector, and having the reservoir separable from the means of controlling the regulating the fluid flow. While at the same time keeping the objectives of simplicity, function, and minimal manufacturing cost paramount. This requires a reservoir that has an easily controllable interior volume adjustment with reduced risk of rupture, breakage, or leakage of the reservoir fluid and with the reservoir having a reduced risk of accidental spillage of the fluid from the reservoir.

### SUMMARY OF INVENTION

A fluid flushing apparatus for manually clearing a fluid line of a fluid bearing debris, the fluid flushing apparatus includes an outer surrounding sidewall having a longitudinal axis. The outer surrounding sidewall having an external surface and an interior surface that defines a first interior, the outer surrounding sidewall also having an inlet end portion and an oppositely disposed flange end portion that is positioned about the longitudinal axis that is adjacent to the external surface. The inlet end portion being adapted to attach to an inlet of the fluid line, further the inlet end portion having a first check valve disposed therein, wherein the first check valve allows fluid communication from the inlet fluid line to the first interior and the first check valve substantially prevents fluid communication from the first interior to the inlet fluid line.

Also included in the fluid flushing apparatus is an inner surrounding sidewall having a long axis, the inner surrounding sidewall having a primary end portion and an opposing secondary end portion, the inner surrounding sidewall having an outside surface and an inside surface that defines a first void therethrough. The first void facilitates fluid communication from the primary end portion to the secondary end portion, the outside surface is a slip fit with the interior surface along the long axis that is co-axial with the longitudinal axis forming a composite axis, wherein the inner surrounding sidewall is disposed within a portion of the first interior. This is such that when the inlet end portion and the secondary end portion are manually drawn apart from one another along the composite axis a second void is formed as between the inlet end portion and the primary end portion. The secondary end portion being adapted to attach to an outlet of the fluid line, further the secondary end portion having a second check valve disposed therein, wherein the second check valve allows fluid communication from the first void to the outlet of the fluid line. The second check valve substantially prevents fluid communication from the outlet of the fluid line to the first void, wherein operationally when the second void is formed, fluid communication occurs from the inlet fluid line to the second void. Further, when the inlet end portion and the secondary end portion are manually pushed toward one another along the composite axis, fluid communication occurs from the second void through the first void to the outlet of the fluid line, thereby moving the debris from the inlet of the fluid line to the outlet of the fluid line.

In the embodiment of use with a bladder catheter, the fluid flushing apparatus basically draws in urine from the bladder therethrough the inlet end portion as the outer and inner surrounding sidewalls are manually drawn apart from one another, wherein the fluid flushing apparatus expels the urine therethrough the secondary end portion to the urine storage vessel via pushing together the inner and outer surrounding sidewalls, with the overall purpose of removing clogging debris from the fluid line that could impair the flow of urine from the bladder. This requirement to keep the fluid line from the bladder free of debris and free flowing is important for the patient as there would be a risk of a condition known as Autonomic Dysreflexia which is a neurological phenomenon that causes a rapid and uncontrolled increase in blood pressure, which could cause a stroke among other things.

These and other objects of the present invention will become more readily appreciated and understood from a consideration of the following detailed description of the exemplary embodiments of the present invention when taken together with the accompanying drawings, in which;

### BRIEF DESCRIPTION OF DRAWINGS

FIG. 1 shows a perspective view of the fluid flushing apparatus with the composite axis as assembled with the inlet end portion and the secondary end portion manually pushed toward one another, plus also shown is the attached adaption of barbed or threaded inlet and outlet extensions, the outer surrounding sidewall with the flange, and the means for limiting the relative manual drawing apart movement in the form of a collar;

FIG. 2 shows a cross sectional perspective view of the fluid flushing apparatus with the composite axis made up of the co-axial combination of the longitudinal axis and the long axis as assembled, with the inlet end portion and the secondary end portion manually drawn apart from one another, plus also shown is the attached adaption of barbed or threaded inlet and outlet extensions, the outer surrounding sidewall with the flange, the means for limiting the relative manual drawing apart movement in the form of a collar, the external and interior surfaces, the first interior, the inner surrounding sidewall, the primary end portion, the outside surface, the slip fit, the rib, the necked down portion, and showing the inner surrounding sidewall disposed within a portion of the first interior;

FIG. 3 shows a semi exploded cross sectional perspective view of the fluid flushing apparatus with the composite axis made up of the co-axial combination of the longitudinal axis and the long axis, as assembled with the inlet end portion and the secondary end portion manually drawn apart from one another, plus also shown is the attached adaption of barbed or threaded inlet and outlet extensions, the outer surrounding sidewall with the flange, the means for limiting the relative manual drawing apart movement in the form of a collar, the external and interior surfaces, the first interior, the inner surrounding sidewall, the primary end portion, the outside surface, the slip fit, the rib, the necked down portion, and showing the inner surrounding sidewall disposed within a portion of the first interior;

FIG. 4 shows an exploded perspective view of the fluid flushing apparatus with the composite axis made up of the co-axial combination of the longitudinal axis and the long axis, as assembled with the inlet end portion and the secondary end portion manually drawn apart from one another, plus also shown is the attached adaption of barbed or threaded inlet and outlet extensions, the outer surrounding sidewall with the flange, the means for limiting the relative manual drawing apart movement in the form of a collar that is shown removed, the external and interior surfaces, the first interior, the inner surrounding sidewall, the primary end portion, the outside surface, the slip fit, the rib, and the necked down portion;

FIG. 5 shows an exploded perspective view of the fluid flushing apparatus with the composite axis made up of the co-axial combination of the longitudinal axis and the long axis as assembled, with the inlet end portion with the first check valve and the secondary end portion with the second check valve, with the inner and outer surrounding sidewalls manually drawn apart from one another, plus also shown is the attached adaption of barbed or threaded inlet and outlet extensions, the outer surrounding sidewall with the flange, the means for limiting the relative manual drawing apart movement in the form of a collar that is shown removed, the external and interior surfaces, the first interior, the inner surrounding sidewall, the primary end portion, the outside surface, the slip fit, the rib, and the necked down portion;

FIG. 6 shows an exploded cross sectional perspective view of the fluid flushing apparatus with the composite axis made up of the co-axial combination of the longitudinal axis and the long axis as assembled, with the inlet end portion with the first check valve and the secondary end portion with the second check valve, with the inner and outer surrounding sidewalls manually drawn apart from one another, plus also shown is the attached adaption of barbed or threaded inlet and outlet extensions, the outer surrounding sidewall with the flange, the means for limiting the relative manual drawing apart movement in the form of a collar that is shown removed, the external and interior surfaces, the first interior, the inner surrounding sidewall, the primary end portion, the outside surface, the inside surface forming the first void, the slip fit, the rib, and the necked down portion;

FIG. 7 shows a cross sectional perspective view of the fluid flushing apparatus with the composite axis as assembled with the inlet end portion with the first check valve including the first resilient sphere having free movement with the open first chamber, the receiving seat of the first partial chamfer, the first channeled radius, the first channel, and the secondary end portion, the second check valve including the second resilient sphere having free movement with the open second chamber, the receiving seat of the second partial chamfer, the second channeled radius, the second channel, with the inlet end portion and the secondary end portion manually pushed toward one another, plus also shown is the attached adaption of barbed or threaded inlet and outlet extensions, the flow restrictions of the inlet and outlet, the outer surrounding sidewall showing the external and interior surfaces, the first interior, with the flange, and the means for limiting the relative manual drawing apart movement in the form of a collar, the inner surrounding sidewall showing the primary end portion, outside and inside surfaces, the first void, the slip fit, the inner surrounding sidewall being disposed within a portion of the first interior, the rib, and the necked down portion;

FIG. 8 shows a cross sectional perspective view of the fluid flushing apparatus with the composite axis as assembled having the manually drawing apart of the inlet end portion and the secondary end portion, with the inlet end portion with the first check valve including the first resilient sphere within the open first chamber, the receiving seat of the first partial chamfer, the first resilient sphere seated against the first channeled radius, with the first channel thereby allowing fluid communication from the inlet end portion to the second void, and the secondary end portion, the second check valve including the second resilient sphere within the open second chamber, the receiving seat of the second partial chamfer with the second resilient sphere resting against the second partial chamfer preventing fluid communication from the outlet extension to the first void, also shown is the second channeled radius, the second channel, with the inlet end portion and the secondary end portion manually drawn apart from one another, plus also shown is the attached adaption of barbed or threaded inlet and outlet extensions, the flow restrictions of the inlet and outlet, the outer surrounding sidewall showing the external and interior surfaces, the first interior, with the flange, and the means for limiting the relative manual drawing apart movement in the form of a collar, the inner surrounding sidewall showing the primary end portion, outside and inside surfaces, the first void, the slip fit, the inner surrounding sidewall being disposed within a portion of the first interior, the rib, and the necked down portion;

FIG. 9 shows a cross sectional perspective view of the fluid flushing apparatus with the composite axis as assembled having the manually pushing toward one another of the inlet end portion and the secondary end portion, with the inlet end portion with the first check valve including the first resilient sphere within the open first chamber, the receiving seat of the first partial chamfer, the first resilient sphere seated against the first partial chamfer thereby preventing fluid communication from the first interior to the inlet extension, further shown is the secondary end portion, the second check valve including the second resilient sphere within the open second chamber, the receiving seat of the second partial chamfer with the second resilient sphere resting against the second channeled radius allowing fluid communication from the first void to the outlet extension through the second channeled radius via the second channel, with the inlet end portion and the secondary end portion manually toward one one another, plus also shown is the attached adaption of barbed or threaded inlet and outlet extensions, the flow restrictions of the inlet and outlet, the outer surrounding sidewall showing the external and interior surfaces, the first interior, with the flange, and the means for limiting the relative manual drawing apart movement in the form of a collar, the inner surrounding sidewall showing the primary end portion, outside and inside surfaces, the first void, the slip fit, the inner surrounding sidewall being disposed within a portion of the first interior, the rib, and the necked down portion; and

FIG. 10 shows a use elevation view drawing of the fluid flushing apparatus with the inlet end portion, the outer surrounding sidewall, the inner surrounding sidewall, the secondary end portion, having the inlet end portion in fluid communication with the inlet of the fluid line that would catch drainage from a bladder catheter, and the secondary end portion in fluid communication with the outlet of the fluid line and the subsequent fluid communication to a storage vessel, wherein over time clogging debris can form within the inlet from the bladder fluid line that can impair bladder drainage leading to adverse consequences for the patient, wherein the fluid flushing apparatus is operational to help remove the debris from the fluid line thereby helping to prevent impaired bladder drainage.

### REFERENCE NUMBERS IN DRAWINGS

50 Fluid flushing apparatus

55 Fluid line

60 Inlet of fluid line 55

65 Outlet of fluid line 55

70 Fluid

75 Debris in the fluid 70

80 Outer surrounding sidewall

85 Longitudinal axis of the outer surrounding sidewall 80

90 External surface of the outer surrounding sidewall 80

95 Interior surface of the outer surrounding sidewall 80

100 First interior of the outer surrounding sidewall 80

105 Inlet end portion of the outer surrounding sidewall 80

110 Flange end portion of the outer surrounding sidewall 80

115 Adaption to attach the inlet end portion 105 to the inlet 60 of the fluid line 55

120 Inlet extension of the adaption 115 to attach the inlet end portion 105 to the inlet 60 of the fluid line 55

125 Barbs and threads of the inlet extension 120

130 Flow restriction of the inlet extension 120

135 First check valve

140 First resilient sphere

145 Free movement of the first resilient sphere 140

150 Open first chamber

155 First partial chamfer of the open first chamber 150

160 Receiving seat of the first partial chamfer 155 for the first resilient sphere 140

165 First channeled radius

170 Received and in contact of first resilient sphere 140 to the first partial chamber 155

175 Received and in contact of first resilient sphere 140 to the first channeled radius 165

180 First channel of the first channeled radius 165

185 Allowed fluid communication of the first check valve 135

190 Prevented fluid communication of the first check valve 135

195 Inner surrounding sidewall

200 Long axis of the inner surrounding sidewall 195

205 Primary end portion of the inner surrounding sidewall 195

210 Secondary end portion of the inner surrounding sidewall 195

215 Outside surface of the inner surrounding sidewall 195

220 Inside surface of the inner surrounding sidewall 195

225 First void of the inner surrounding sidewall 195

230 Slip fit of the outside surface 215 to the interior surface 95

235 Composite axis of the longitudinal axis 85 and the long axis 200

240 Inner surrounding sidewall being disposed within a portion of the first interior 100

245 Rib of the inner surrounding sidewall 195

250 Necked down portion of the inner surrounding sidewall 195

255 Manually drawing apart movement of the inlet end portion 105 and the secondary end portion 210 along the composite axis 235

260 Second void

265 Adaption to attach the secondary end portion 210 to the outlet 65 of the fluid line 55

270 Outlet extension of the adaption 265 to attach the secondary end portion 210 to the outlet 65 of the fluid line 55

275 Barbs and threads of the outlet extension 270

280 Flow restriction of the outlet extension 270

285 Second check valve

290 Second resilient sphere

295 Free movement of the second resilient sphere 290

300 Open second chamber

305 Second partial chamfer of the open second chamber 300

310 Receiving seat of the second partial chamfer 305 for the second resilient sphere 290

315 Second channeled radius

320 Received and in contact of second resilient sphere 290 to the second partial chamber 305

325 Received and in contact of second resilient sphere 290 to the second channeled radius 315

330 Second channel of the second channeled radius 315

335 Allowed fluid communication of the second check valve 285

340 Prevented fluid communication of the second check valve 285

345 Manually pushing toward one another movement of the inlet end portion 105 and the secondary end portion 210 along the composite axis 235

350 Means for limiting the relative manual drawing apart movement 255 along the composite axis 235 as between the inlet end portion 105 and said secondary end portion 210

355 Collar

356 Interference of collar 355 and rib 245 for the movement limit 370 at the outside surface 215

360 Removable engagement of collar 355

370 Movement limit for drawing apart movement 255

### DETAILED DESCRIPTION

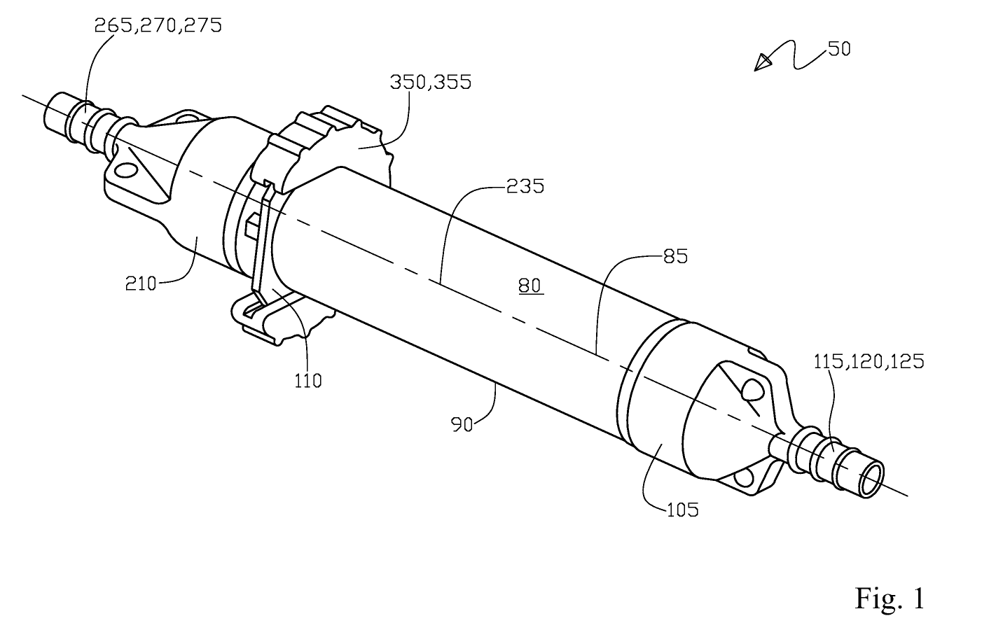

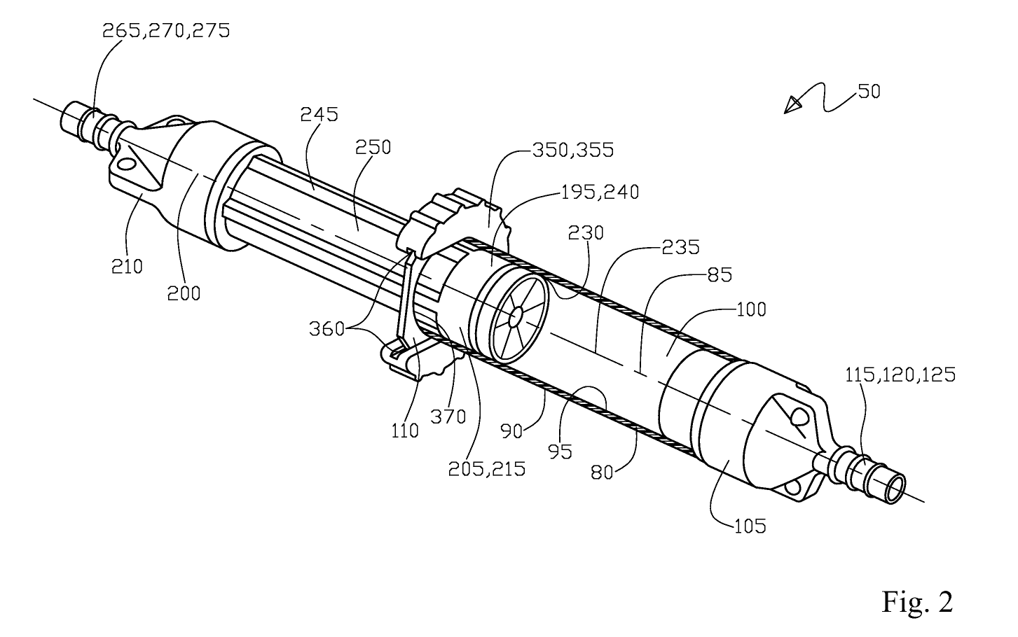

With initial reference to FIG. 1 shown is a perspective view of the fluid flushing apparatus 50 with the composite axis 235 as assembled with the inlet end portion 105 and the secondary end portion 210 manually pushed 345 toward one another, plus also shown is the attached adaption 115, 265 of barbed or threaded 125, 275 inlet 120 and outlet 270 extensions, the outer surrounding sidewall 80 with the flange 110, and the means 350 for limiting the relative manual drawing apart movement 255 in the form of a collar 355. Continuing, FIG. 2 shows a cross sectional perspective view of the fluid flushing apparatus 50 with the composite axis 235 made up of the co-axial combination of the longitudinal axis 85 and the long axis 200, as assembled with the inlet end portion 105 and the secondary end portion 210 manually drawn apart 255 from one another. Plus also shown in FIG. 2 is the attached adaption 115, 265 of barbed or threaded 125, 275 inlet 120 and outlet 270 extensions, the outer surrounding sidewall 80 with the flange 110, the means 350 for limiting the relative manual drawing apart movement 255 in the form of a collar 355, the external 90 and interior 95 surfaces, the first interior 100. Further shown in FIG. 2, is the inner surrounding sidewall 195, the primary end portion 205, the outside surface 215, the slip fit 230, the rib 245, the necked down portion 250, and showing the inner surrounding sidewall 195 disposed within a portion 240 of the first interior 100.

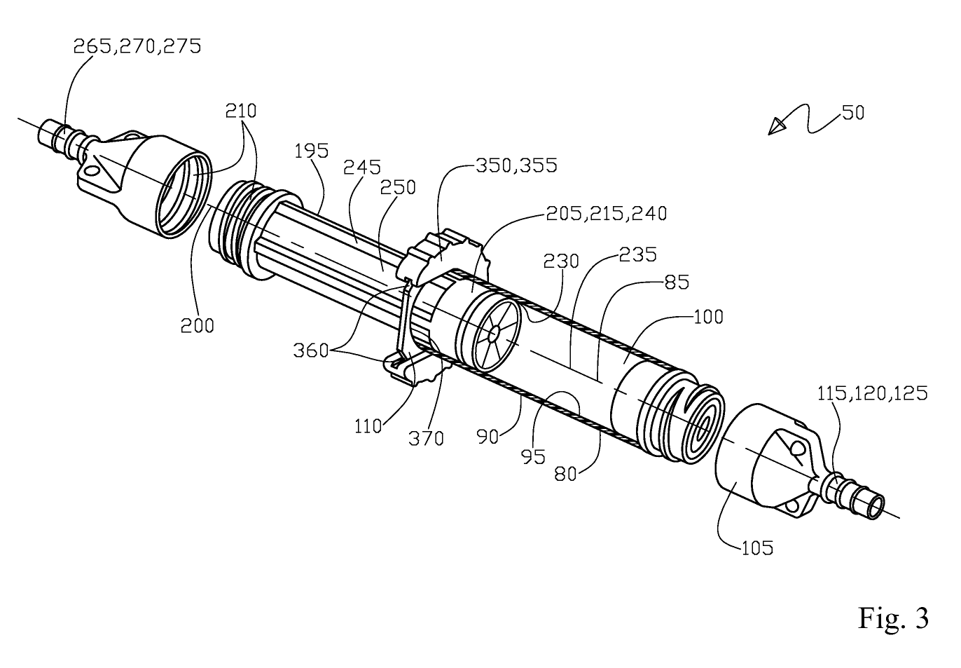

Next, FIG. 3 shows a semi exploded cross sectional perspective view of the fluid flushing apparatus 50 with the composite axis 235 made up of the co-axial combination of the longitudinal axis 85 and the long axis 200, as assembled with the inlet end portion 105 and the secondary end portion 210 manually drawn apart 255 from one another. Plus also shown in FIG. 3 is the attached adaption 115, 265 of barbed or threaded 125, 275 inlet 120 and outlet 270 extensions, the outer surrounding sidewall 80 with the flange 110, the means 350 for limiting the relative manual drawing apart movement 255 in the form of a collar 355, the external 90 and interior 95 surfaces. FIG. 3 also shows the first interior 100, the inner surrounding sidewall 195, the primary end portion 205, the outside surface 215, the slip fit 230, the rib 245, the necked down portion 250, and showing the inner surrounding sidewall 195 disposed within a portion 240 of the first interior 100.

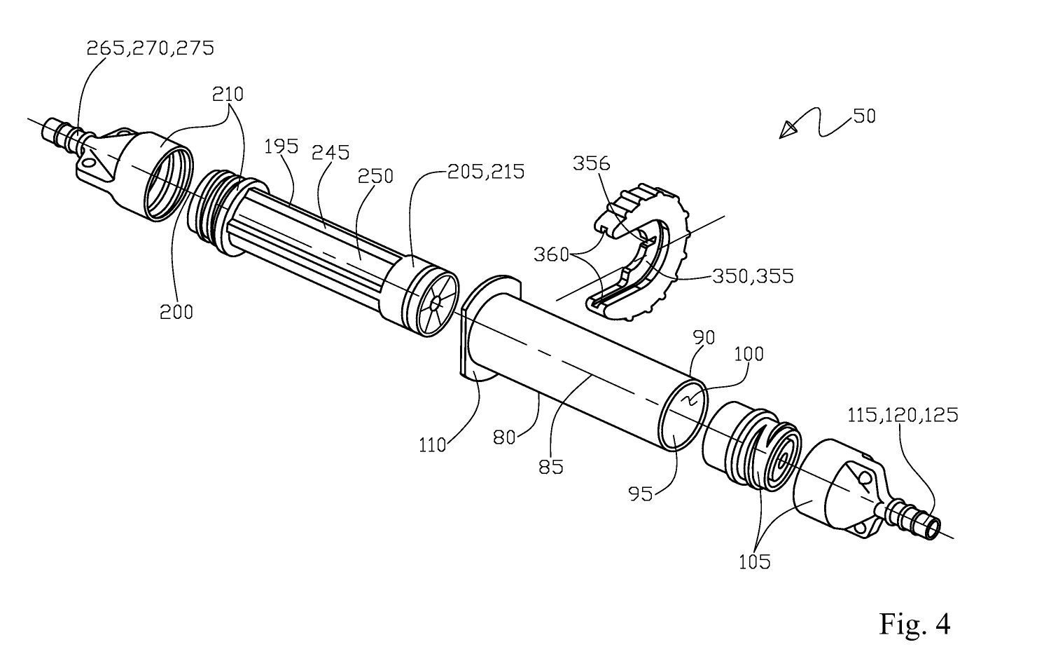

Yet further, FIG. 4 shows an exploded perspective view of the fluid flushing apparatus 50 with the composite axis 235 made up of the co-axial combination of the longitudinal axis 85 and the long axis 200, as assembled with the inlet end portion 105 and the secondary end portion 210 manually drawn apart 255 from one another. Plus also shown in FIG. 4 is the attached adaption 115, 265 of barbed or threaded 125, 275 inlet 120 and outlet 270 extensions, the outer surrounding sidewall 80 with the flange 110, the means 350 for limiting the relative manual drawing apart movement 255 in the form of a collar 355 that is shown removed. FIG. 4 also shows the external 90 and interior 95 surfaces, the first interior 100, the inner surrounding sidewall 195, the primary end portion 205, the outside surface 215, the slip fit 230, the rib 245, and the necked down portion 250.

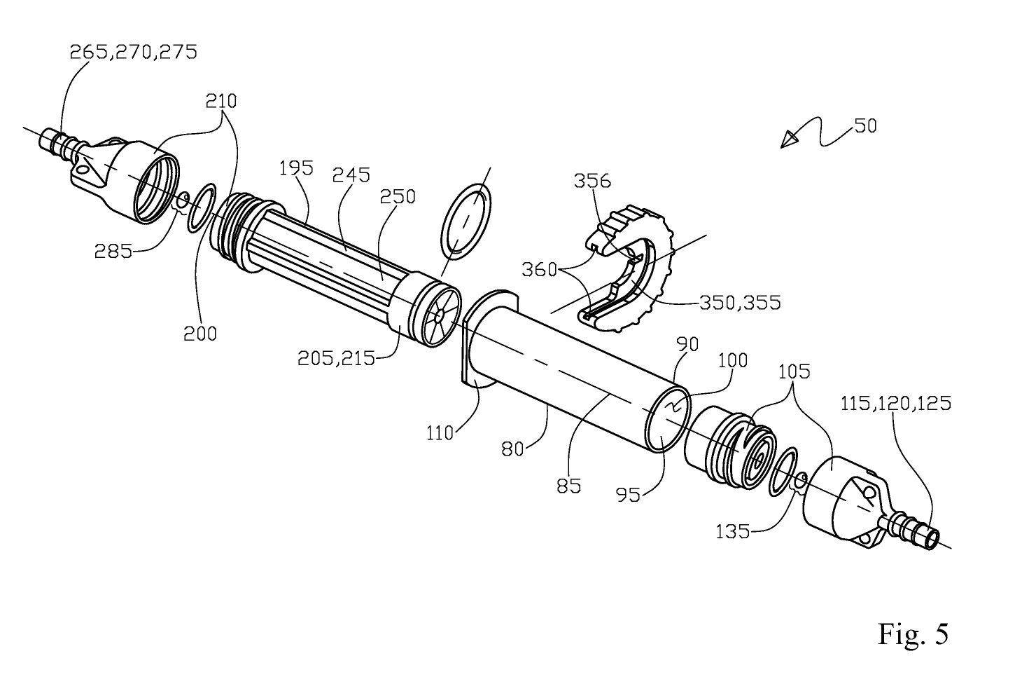

Continuing, FIG. 5 shows an exploded perspective view of the fluid flushing apparatus 50 with the composite axis 235 made up of the co-axial combination of the longitudinal axis 85 and the long axis 200, as assembled with the inlet end portion 105 with the first check valve 135 and the secondary end portion 210 with the second check valve 285 manually drawn apart 255 from one another. Plus also shown in FIG. 5 is the attached adaption 115, 265 of barbed or threaded 125, 275 inlet 120 and outlet 270 extensions, the outer surrounding sidewall 80 with the flange 110, the means 350 for limiting the relative manual drawing apart movement 255 in the form of a collar 355 that is shown removed. Further shown in FIG. 5 is the external 90 and interior 95 surfaces, the first interior 100, the inner surrounding sidewall 195, the primary end portion 205, the outside surface 215, the slip fit 230, the rib 245, and the necked down portion 250.

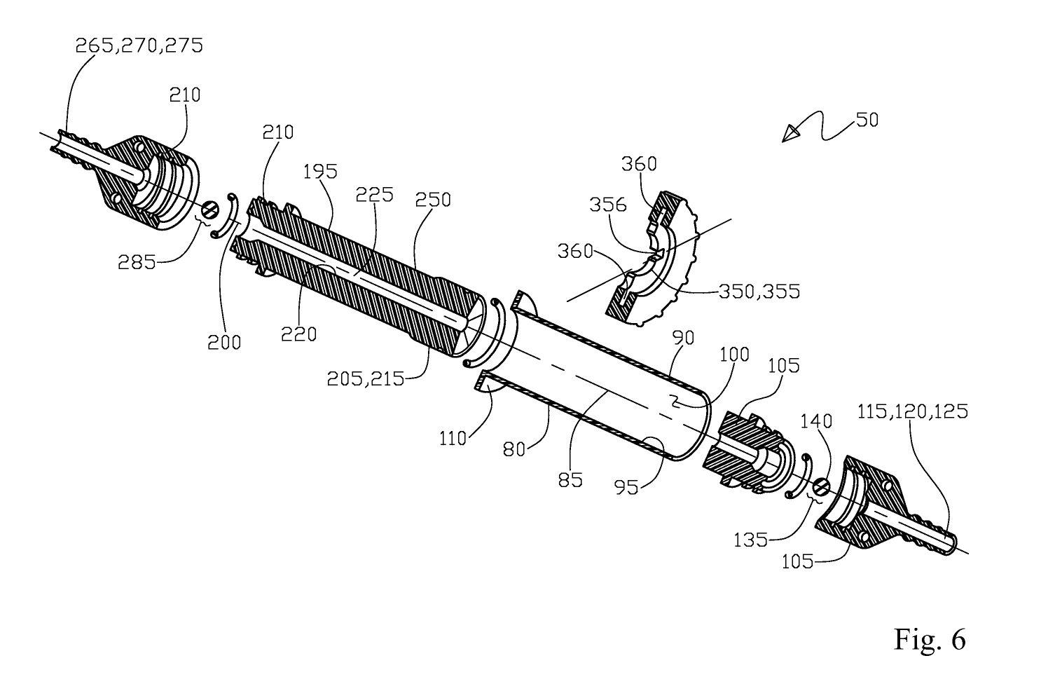

Moving onward, FIG. 6 shows an exploded cross sectional perspective view of the fluid flushing apparatus 50 with the composite axis 235 made up of the co-axial combination of the longitudinal axis 85 and the long axis 200, as assembled with the inlet end portion 105 with the first check valve 135 and the secondary end portion 210 with the second check valve 285 manually drawn apart 255 from one another. Plus also shown on FIG. 6 is the attached adaption 115, 265 of barbed or threaded 125, 275 inlet 120 and outlet 270 extensions, the outer surrounding sidewall 80 with the flange 110, the means 350 for limiting the relative manual drawing apart movement 255 in the form of a collar 355 that is shown removed. Further shown in FIG. 6 is the external 90 and interior 95 surfaces, the first interior 100, the inner surrounding sidewall 195, the primary end portion 205, the outside surface 215, the inside surface 220 forming the first void 225, the slip fit 230, the rib 245, and the necked down portion 250.

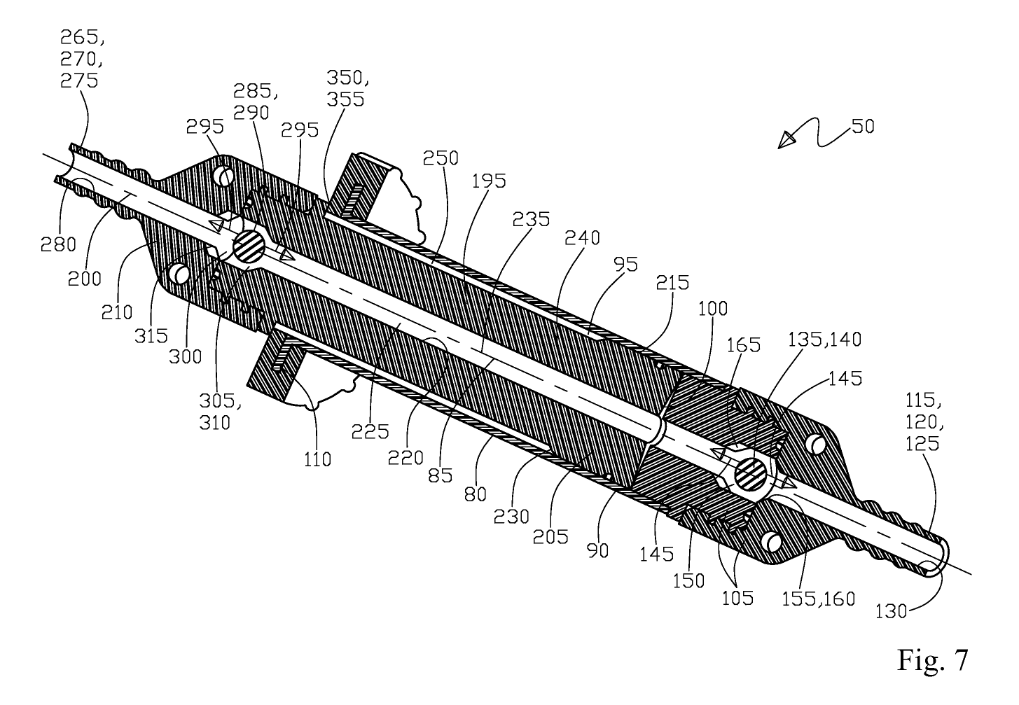

Next, FIG. 7 shows a cross sectional perspective view of the fluid flushing apparatus 50 with the composite axis 235 as assembled with the inlet end portion 105 with the first check valve 135 including the first resilient sphere 140 having free movement 145 with the open first chamber 150, the receiving seat 160 of the first partial chamfer 155, the first channeled radius 165, the first channel 180, and the secondary end portion 210. Also shown in FIG. 7 is the second check valve 285 including the second resilient sphere 290 having free movement 295 with the open second chamber 300, the receiving seat 310 of the second partial chamfer 305, the second channeled radius 315, the second channel 330, with the inlet end portion 105 and the secondary end portion 210 manually pushed toward one another 345. Plus also shown in FIG. 7 is the attached adaption 115, 265 of barbed or threaded 125, 275 inlet 120 and outlet 270 extensions, the flow restrictions of the inlet 130 and outlet 280, the outer surrounding sidewall 80 showing the external 90 and interior 95 surfaces, the first interior 100, with the flange 110, and the means 350 for limiting the relative manual drawing apart movement 255 in the form of a collar 355, the inner surrounding sidewall 195 showing the primary end portion 205. Also FIG. 7 shows the outside 215 and inside 220 surfaces, the first void 225, the slip fit 230, the inner surrounding sidewall 195 being disposed within a portion 240 of the first interior 100, the rib 245, and the necked down portion 250.

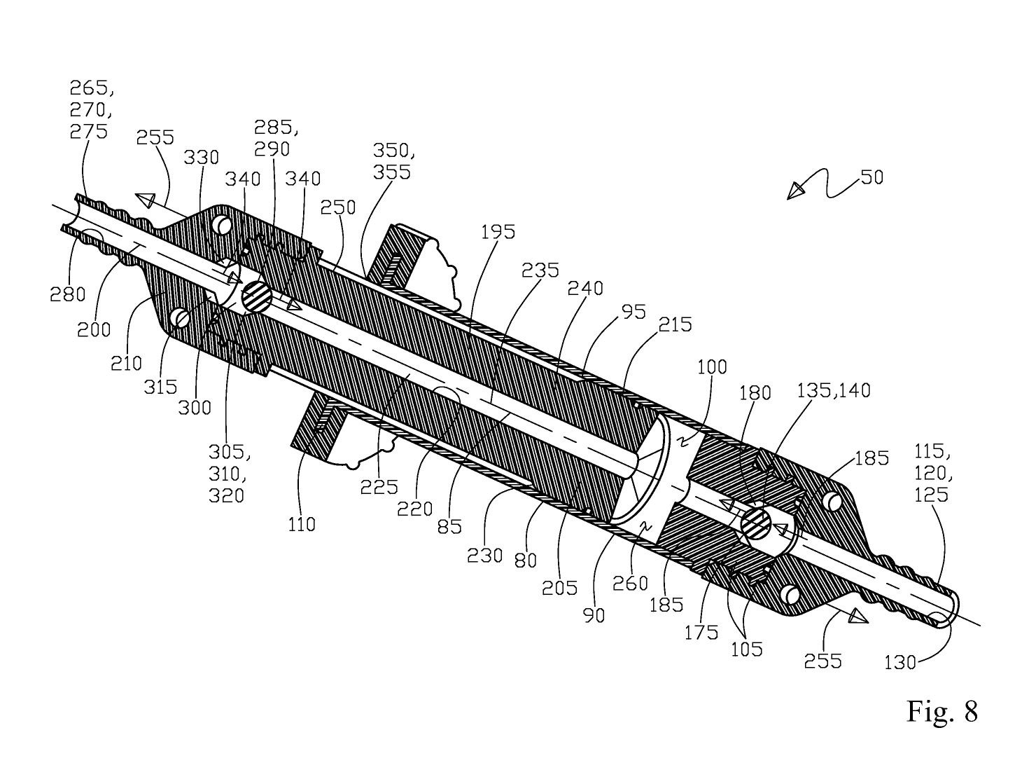

Further, FIG. 8 shows a cross sectional perspective view of the fluid flushing apparatus 50 with the composite axis 235 as assembled having the manually drawing apart 255 of the inlet end portion 105 and the secondary end portion 210, with the inlet end portion 105 with the first check valve 135 including the first resilient sphere 140 within the open first chamber 150. Further shown in FIG. 8 is the receiving seat 160 of the first partial chamfer 155, the first resilient sphere 140 seated 175 against the first channeled radius 165, with the first channel 180 thereby allowing fluid communication 185 from the inlet end portion 105 to the second void 260. Also in FIG. 8 shown is the secondary end portion 210, the second check valve 285 including the second resilient sphere 290 within the open second chamber 300, the receiving seat 310 of the second partial chamfer 305 with the second resilient sphere 290 resting against 320 the second partial chamfer 305 preventing fluid communication 340 from the outlet extension 270 to the first void 225. Further shown in FIG. 8 is the second channeled radius 315, the second channel 330, with the inlet end portion 105 and the secondary end portion 210 manually drawn apart 255 from one another, plus also shown is the attached adaption 115, 265 of barbed or threaded 125, 275 inlet 120 and outlet 270 extensions, the flow restrictions of the inlet 130 and outlet 280, the outer surrounding sidewall 80 showing the external 90 and interior 95 surfaces, the first interior 100, with the flange 110. FIG. 8 also shows the means 350 for limiting the relative manual drawing apart movement 255 in the form of a collar 355, the inner surrounding sidewall 195 showing the primary end portion 205, outside 215 and inside 220 surfaces, the first void 225, the slip fit 230, the inner surrounding sidewall 195 being disposed within a portion 240 of the first interior 100, the rib 245, and the necked down portion 250.

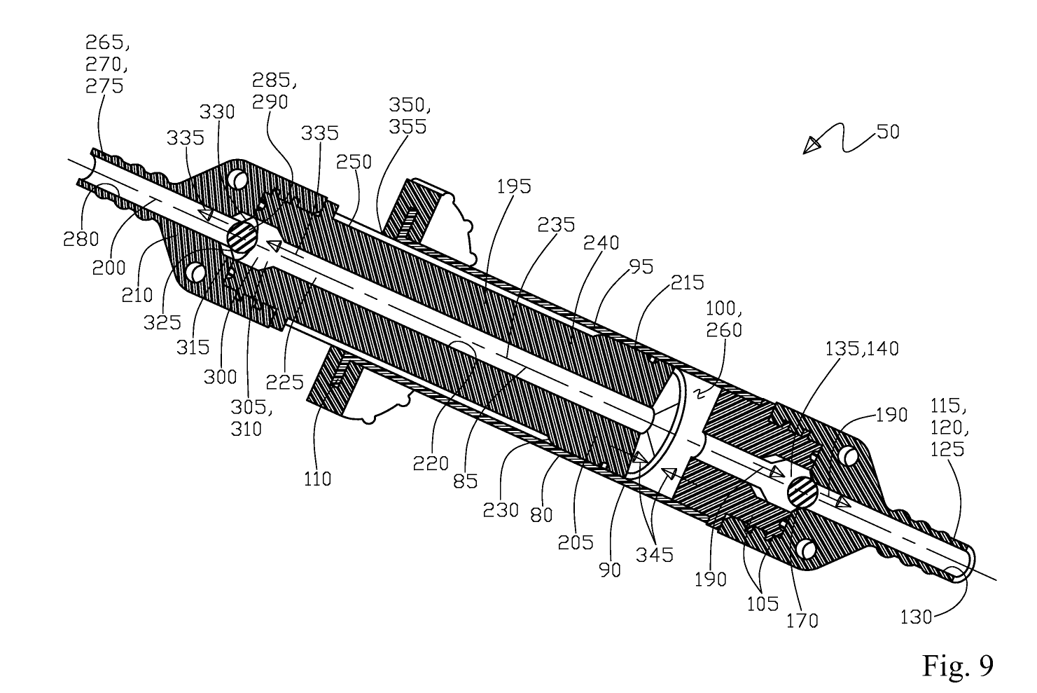

Moving onward, FIG. 9 shows a cross sectional perspective view of the fluid flushing apparatus 50 with the composite axis 235 as assembled having the manually pushing toward one another 345 of the inlet end portion 105 and the secondary end portion 210, with the inlet end portion 105 with the first check valve 135 including the first resilient sphere 140 within the open first chamber 150. Further FIG. 9 shows the receiving seat 160 of the first partial chamfer 155, the first resilient sphere 140 seated 170 against the first partial chamfer 155 thereby preventing fluid communication 190 from the first interior 100 to the inlet extension 120. Further shown in FIG. 9 is the secondary end portion 210, the second check valve 285 including the second resilient sphere 290 within the open second chamber 300, the receiving seat 310 of the second partial chamfer 305 with the second resilient sphere 290 resting 325 against the second channeled radius 315 allowing fluid communication 335 from the first void 225 to the outlet extension 270 through the second channeled radius 315 via the second channel 330, with the inlet end portion 105 and the secondary end portion 210 manually toward 345 one another. Plus also shown in FIG. 9 is the attached adaption 115, 265 of barbed or threaded 125, 275 inlet 120 and outlet 270 extensions, the flow restrictions of the inlet 130 and outlet 280, the outer surrounding sidewall 80 showing the external 90 and interior 95 surfaces, the first interior 100, with the flange 110. In addition FIG. 9 shows the means 350 for limiting the relative manual drawing apart movement 255 in the form of a collar 355, the inner surrounding sidewall 195 showing the primary end portion 205, outside 215 and inside 220 surfaces, the first void 225, the slip fit 230, the inner surrounding sidewall 195 being disposed within a portion 240 of the first interior 100, the rib 245, and the necked down portion 250.

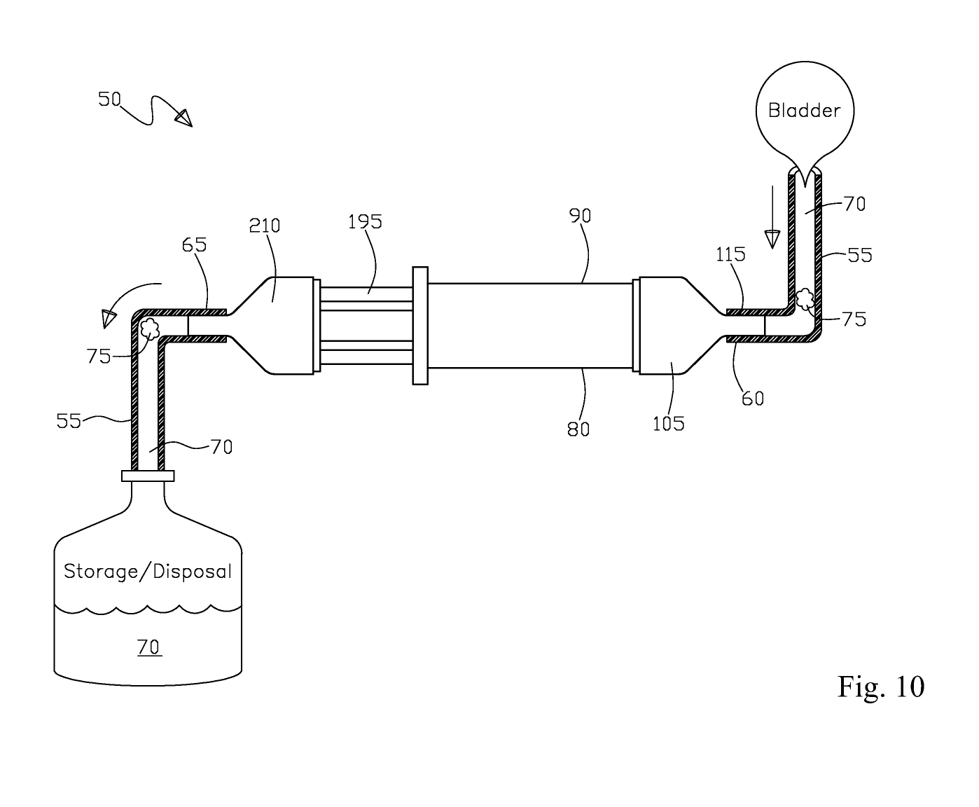

Continuing, FIG. 10 shows a use view drawing of the fluid flushing apparatus 50 with the inlet end portion 105, the outer surrounding sidewall 80, the inner surrounding sidewall 195, the secondary end portion 210, having the inlet end portion 105 in fluid communication with the inlet 60 of the fluid line 55 that would catch drainage fluid 70 from a bladder catheter. Also shown in FIG. 10 is the secondary end portion 210 in fluid communication with the outlet 65 of the fluid line 55 and the subsequent fluid communication to a storage vessel for fluid 70 storage. Wherein over time clogging debris 75 can form within the inlet 60 of the fluid line 55 from the bladder that can impair bladder drainage leading to adverse consequences for the patient, wherein the fluid flushing apparatus 50 is operational to help remove the debris 75 from the fluid line 55 thereby helping to prevent impaired bladder drainage, as shown in FIG. 10.

With reference to FIGS. 1 through 9 for structure and FIG. 10 for usage, a fluid flushing apparatus 50 for manually clearing a fluid line 55 of a fluid 70 bearing debris 75 is disclosed wherein the fluid flushing apparatus 50 includes an outer surrounding sidewall 80 having a longitudinal axis 85. The outer surrounding sidewall 80 having an external surface 90 and an interior surface 95 that defines a first interior 100, the outer surrounding sidewall 80 also having an inlet end portion 105 and an oppositely disposed flange end portion 110 that is positioned about the longitudinal axis 85 that is adjacent to the external surface 90. The inlet end portion 105 being adapted to attach 115 to an inlet 60 of the fluid line 55, further the inlet end portion 105 having a first check valve 135 disposed therein, wherein the first check 135 valve allows fluid communication 185 from the inlet fluid line 60 to the first interior 100 and the first check valve 135 substantially prevents fluid communication 190 from the first interior 100 to the inlet fluid line 60, see in particular FIGS. 8 and 9.

Also included in the fluid flushing apparatus 50 is an inner surrounding sidewall 195 having a long axis 200, the inner surrounding sidewall 195 having a primary end portion 205 and an opposing secondary end portion 210, the inner surrounding sidewall 195 having an outside surface 215 and an inside surface 220 that defines a first void 225 therethrough. The first void 225 facilitates fluid communication from the primary end portion 205 to the secondary end portion 210, the outside surface 215 is a slip fit 230 with the interior surface 95 along the long axis 200 that is co-axial with the longitudinal axis 85 forming a composite axis 235, wherein the inner surrounding sidewall 195 is disposed within a portion 240 of the first interior 100. This is such that when the inlet end portion 105 and the secondary end portion 210 are manually drawn apart 255 from one another along the composite axis 235 a second void 260 is formed as between the inlet end portion 105 and the primary end portion 205, see FIGS. 7, 8, and 9.

The secondary end portion 210 being adapted to attach to an outlet 65 of the fluid line 55, further the secondary end portion 210 having a second check valve 285 disposed therein, wherein the second check valve 285 allows fluid communication 335 from the first void 225 to the outlet 65 of the fluid line 55. The second check valve 285 substantially prevents fluid communication 340 from the outlet 65 of the fluid line 55 to the first void 225, see FIGS. 7, 8, 9, and 10. Wherein operationally, when the second void 260 is formed, fluid communication occurs from the inlet fluid line 60 to the second void 260. Further, when the inlet end portion 105 and the secondary end portion 210 are manually pushed toward one another 345 along the composite axis 235, fluid communication occurs from the second void 260 through the first void 225 to the outlet 65 of the fluid line 55, thereby moving the debris 75 from the inlet 60 of the fluid line 55 to the outlet 65 of the fluid line 55, again see FIGS. 7, 8, 9, and 10.

Further for the fluid flushing apparatus 50 the first check valve 135 is constructed of a first resilient sphere 140 freely moving 145 along the longitudinal axis 85 within an open first chamber 150 defined by having a first partial chamfer 155 that acts as a sphere 140 receiving seat 170, the first partial chamfer 155 is in fluid communication with the inlet end portion 105 adjacent to the inlet 60 of the fluid line 55, further the first chamber 150 is oppositely defined by a first channeled radius 165 that is adjacent to the first interior 100. Wherein the sphere 140 moves 145 along the longitudinal axis 85 between the first partial chamfer 155 and the first channeled radius 165, see FIGS. 7, 8, and 9. Wherein operationally, when the sphere 140 is received 170 and in contact with the first partial chamfer 155, fluid communication is substantially prevented 190 from the first interior 100 to the inlet 60 fluid line 55, see FIGS. 9 and 10. When the sphere 140 is received 175 and in contact with the first channeled radius 165 fluid communication is allowed 185 via a first channel 180 from the inlet 60 fluid line 55 to the first interior 100, see FIGS. 8 and 10. The preferred material of construction for the sphere 140 is rubber, nitrile rubber, or a suitable equivalent. The first channeled radius 165 first channel 180 is positioned as a fluid passageway therethrough the radius 165, see FIG. 8.

Also on the fluid flushing apparatus 50 the second check valve 285 is constructed of a second resilient sphere 290 freely moving 295 along the long axis 200 within an open second chamber 300 defined by having a second partial chamfer 305 that acts as a sphere receiving seat 310. The second partial chamfer 305 is adjacent to in fluid communication with the first void 225, further the second chamber 300 is oppositely defined by a second channeled radius 315 that is adjacent to and in fluid communication with the outlet 65 of the fluid line 55, wherein the second sphere 290 moves 295 along the long axis 200 between the second partial chamfer 305 and the second channeled radius 315, see FIG. 7. Wherein operationally, when the second sphere 290 is received and in contact 320 with the second partial chamfer 305, fluid communication 340 is substantially prevented from the outlet 65 fluid line 55 to the first void 225, see FIGS. 8 and 10. When the second sphere 290 is received and in contact 325 with the second channeled radius 315 fluid communication is allowed 335 via a second channel 330 from the first void 225 to the outlet 65 of the fluid line 55, see FIGS. 9 and 10. The preferred material of construction for the sphere 290 is rubber, nitrile rubber, or a suitable equivalent. The second channeled radius 315 second channel 330 is positioned as a fluid passageway therethrough the radius 315, see FIG. 9.

Continuing on the fluid flushing apparatus 50, the fluid flushing apparatus 50 can further including a means 350 for limiting the relative manual drawing apart movement 255 along the composite axis 235 as between the inlet end portion 105 and the secondary end portion 210, to operationally prevent inadvertent separation of the inner surrounding sidewall 195 from the outer surrounding sidewall 80, see in particular FIGS. 2, 3, 4, 5, and 6. Further on the means 350 it is preferably constructed of a collar 355 that removably engages 360 the flange end portion 110, see FIGS. 2, 3, 4, 5, and 6. Wherein the collar 355 has an interface 356 that contacts a rib 245 on a necked down portion 250 of the inner surrounding sidewall 195 outside surface 215 for limiting 370 the relative manual drawing apart movement 255, see FIGS. 2, 3, 4, 5, and 6.

Further on the fluid flushing apparatus 50 the inlet end portion 105 preferably has an adaption 115 to attach to the inlet 60 of the fluid line 55 that is constructed of an inlet extension 120 that is selected from the group consisting of barbs and threads 125, as best shown in FIGS. 1 through 9 and installed in use in FIG. 10. Also on the fluid flushing apparatus 50 the secondary end portion 210 preferably has an adaption 265 to attach to the outlet 65 of the fluid line 55 that is constructed of an outlet extension 270 that is selected from the group consisting of barbs and threads 275, as best shown in FIGS. 1 through 9 and installed in use in FIG. 10.

Additionally, on the fluid flushing apparatus 50 the inlet extension 120 is sized with a flow restriction 130 in the form of an orifice to control a flow rate of the fluid 70, the typical fluid 70 (in this case urine) flow rate is about 0.035 milli-Liters per second, however it may be more or less depending upon a particular individuals urine production circumstances, this reflecting the first 140 and second 290 resilient spheres being in the free movement states 145 and 295 respectively, as shown in FIG. 7, however, as depicted in FIGS. 8 and 9, wherein the first 140 and second 290 resilient spheres are seated as previously described, the typical fluid 70 flow rate is about 2.5 milli-Liters per second for clearing debris 75, also as previously described, see also FIG. 10. Further, on the fluid flushing apparatus 50 the outlet extension 270 is sized with a flow restriction 280 in the form of an orifice to control a flow rate of the fluid 70, which would be the same flow rates as previously described for the inlet extension 120 above.

In addition, on the fluid flushing apparatus 50 the outer 80 and inner 195 surrounding sidewalls are preferably constructed of a resilient plastic, or are preferably constructed of materials selected from the group consisting essentially of acrylonitrile butadiene styrene (ABS), polyethylene, polypropylene, nitrile rubber, or a suitable equivalent.

### CONCLUSION

Accordingly, the present invention of a fluid flushing apparatus 50 has been described with some degree of particularity directed to the embodiments of the present invention. It should be appreciated, though, that the present invention is defined by the following claims construed in light of the prior art so modifications the changes may be made to the exemplary embodiments of the present invention without departing from the inventive concepts contained therein.

1. A fluid flushing apparatus for manually clearing a fluid line of a fluid bearing debris, said fluid flushing apparatus comprising:
(a) an outer surrounding sidewall having a longitudinal axis, said outer surrounding sidewall having an external surface and an interior surface that defines a first interior, said outer surrounding sidewall having an inlet end portion and an oppositely disposed flange end portion that is positioned about said longitudinal axis and is adjacent to said external surface, said inlet end portion being adapted to attach to an inlet of the fluid line, further said inlet end portion having a first check valve disposed therein, wherein said first check valve allows fluid communication from the inlet fluid line to said first interior and said first check valve substantially prevents fluid communication from said first interior to the inlet fluid line; and
(b) an inner surrounding sidewall having a long axis, said inner surrounding sidewall having a primary end portion and an opposing secondary end portion, said inner surrounding sidewall having an outside surface and an inside surface that defines a first void therethrough that facilitates fluid communication from said primary end portion to said secondary end portion, said outside surface is a slip fit with said interior surface along said long axis that is co-axial with said longitudinal axis forming a composite axis, wherein said inner surrounding sidewall is disposed within a portion of said first interior, such that when said inlet end portion and said secondary end portion are manually drawn apart from one another along said composite axis a second void is formed as between said inlet end portion and said primary end portion, said secondary end portion being adapted to attach to an outlet of the fluid line, further said secondary end portion having a second check valve disposed therein, wherein said second check valve allows fluid communication from said first void to the outlet of the fluid line and said second check valve substantially prevents fluid communication from the outlet of the fluid line to said first void, wherein operationally when said second void is formed, fluid communication occurs from the inlet fluid line to said second void and when said inlet end portion and said secondary end portion are manually pushed toward one another along said composite axis, fluid communication occurs from said second void through said first void to the outlet of the fluid line, thereby moving the debris from the inlet of the fluid line to the outlet of the fluid line.

2. A fluid flushing apparatus according to claim 1 wherein said first check valve is constructed of a first resilient sphere freely moving along said longitudinal axis within an open first chamber defined by having a first partial chamfer that acts as a sphere receiving seat, said first partial chamfer is in fluid communication with said inlet end portion adjacent to the inlet of the fluid line, further said first chamber oppositely defined by a first channeled radius that is adjacent to said first interior, wherein said sphere moves along said longitudinal axis between said first partial chamfer and said first channeled radius, wherein operationally when said sphere is received and in contact with said first partial chamfer, fluid communication is substantially prevented from said first interior to the inlet fluid line and when said sphere is received and in contact with said first channeled radius fluid communication is allowed via a first channel from the inlet fluid line to said first interior.

3. A fluid flushing apparatus according to claim 2 wherein said second check valve is constructed of a second resilient sphere freely moving along said long axis within an open second chamber defined by having a second partial chamfer that acts as a sphere receiving seat, said second partial chamfer is adjacent to in fluid communication with said first void, further said second chamber oppositely defined by a second channeled radius that is adjacent to and in fluid communication with the outlet of the fluid line, wherein said second sphere moves along said long axis between said second partial chamfer and said second channeled radius, wherein operationally when said second sphere is received and in contact with said second partial chamfer, fluid communication is substantially prevented from the outlet fluid line to said first void and when said second sphere is received and in contact with said second channeled radius fluid communication is allowed via a second channel from said first void to the outlet of the fluid line.

4. A fluid flushing apparatus according to claim 3 further including a means for limiting said relative manual drawing apart movement along said composite axis as between said inlet end portion and said secondary end portion, to operationally prevent inadvertent separation of said inner surrounding sidewall from said outer surrounding sidewall.

5. A fluid flushing apparatus according to claim 4 wherein said means for limiting said relative manual drawing apart movement along said composite axis is constructed of a collar that removably engages said flange end portion, wherein said collar contacts a rib on a necked down portion of said inner surrounding sidewall outside surface for limiting said relative manual drawing apart movement.

6. A fluid flushing apparatus according to claim 5 wherein said inlet end portion adaption to attach to the inlet of the fluid line is constructed of an inlet extension that is selected from the group consisting of barbs and threads.

7. A fluid flushing apparatus according to claim 5 wherein said secondary end portion adaption to attach to the outlet of the fluid line is constructed of an outlet extension that is selected from the group consisting of barbs and threads.

8. A fluid flushing apparatus according to claim 6 wherein said inlet extension is sized with a flow restriction to control a flow rate of the fluid.

9. A fluid flushing apparatus according to claim 7 wherein said outlet extension is sized with a flow restriction to control a flow rate of the fluid.

10. A fluid flushing apparatus according to claim 5 wherein said outer and inner surrounding sidewalls are constructed of a resilient plastic.

11. A fluid flushing apparatus according to claim 5 wherein said outer and inner surrounding sidewalls are constructed of materials selected from the group consisting essentially of acrylonitrile butadiene styrene (ABS), polyethylene, polypropylene, and nitrile rubber materials.

12. A fluid flushing apparatus for manually clearing a fluid line of a fluid bearing debris, said fluid flushing apparatus comprising:
(a) an outer surrounding sidewall having a longitudinal axis, said outer surrounding sidewall having an external surface and an interior surface that defines a first interior, said outer surrounding sidewall having an inlet end portion and an oppositely disposed flange end portion that is positioned about said longitudinal axis and is affixed to said external surface, said inlet end portion being adapted to attach to an inlet of the fluid line, further said inlet end portion having a first check valve disposed therein, wherein said first check valve is constructed of a first resilient sphere freely moving along said longitudinal axis within an open first chamber defined by having a first partial chamfer that acts as a sphere receiving seat, said first partial chamfer is in fluid communication with said inlet end portion adjacent to the inlet of the fluid line, further said first chamber oppositely defined by a first channeled radius that is adjacent to said first interior, wherein said sphere moves along said longitudinal axis between said first partial chamfer and said first channeled radius, wherein operationally when said sphere is received and in contact with said first partial chamfer, fluid communication is substantially prevented from said first interior to the inlet fluid line and when said sphere is received and in contact with said first channeled radius, fluid communication is allowed via a first channel from the inlet fluid line to said first interior; and
(b) an inner surrounding sidewall having a long axis, said inner surrounding sidewall having a primary end portion and an opposing secondary end portion, said inner surrounding sidewall having an outside surface and an inside surface that defines a first void therethrough that facilitates fluid communication from said primary end portion to said secondary end portion, said outside surface is a slip fit with said interior surface along said long axis that is co-axial with said longitudinal axis forming a composite axis, wherein said inner surrounding sidewall is disposed within a portion of said first interior, such that when said inlet end portion and said secondary end portion are manually drawn apart from one another along said composite axis a second void is formed as between said inlet end portion and said primary end portion, said secondary end portion being adapted to attach to an outlet of the fluid line, further said secondary end portion having a second check valve disposed therein, wherein said second check valve is constructed of a second resilient sphere freely moving along said long axis within an open second chamber defined by having a second partial chamfer that acts as a sphere receiving seat, said second partial chamfer is adjacent to and in fluid communication with said first void, further said second chamber is oppositely defined by a second channeled radius that is adjacent to and in fluid communication with the outlet of the fluid line, wherein said second sphere moves along said long axis between said second partial chamfer and said second channeled radius, wherein operationally when said second sphere is received and in contact with said second partial chamfer, fluid communication is substantially prevented from the outlet fluid line to said first void and when said second sphere is received and in contact with said second channeled radius fluid communication is allowed via a second channel from said first void to the outlet of the fluid line, wherein operationally when said second void is formed, fluid communication occurs from the inlet fluid line to said second void and when said inlet end portion and said secondary end portion are manually pushed toward one another along said composite axis, fluid communication occurs from said second void through said first void to the outlet of the fluid line, thereby moving the debris from the inlet of the fluid line to the outlet of the fluid line.

13. A fluid flushing apparatus according to claim 12 further including a means for limiting said relative manual drawing apart movement along said composite axis as between said inlet end portion and said secondary end portion, to operationally prevent inadvertent separation of said inner surrounding sidewall from said outer surrounding sidewall.

14. A fluid flushing apparatus according to claim 13 wherein said means for limiting said relative manual drawing apart movement along said composite axis is constructed of a collar that removably engages said flange end portion, wherein said collar contacts a rib on a necked down portion of said inner surrounding sidewall outside surface for limiting said relative manual drawing apart movement.

15. A fluid flushing apparatus according to claim 14 wherein said inlet end portion adaption to attach to the inlet of the fluid line is constructed of an inlet extension that is selected from the group consisting of barbs and threads.

16. A fluid flushing apparatus according to claim 14 wherein said secondary end portion adaption to attach to the outlet of the fluid line is constructed of an outlet extension that is selected from the group consisting of barbs and threads.

17. A fluid flushing apparatus according to claim 15 wherein said inlet extension is sized with a flow restriction to control a flow rate of the fluid.

18. A fluid flushing apparatus according to claim 16 wherein said outlet extension is sized with a flow restriction to control a flow rate of the fluid.

19. A fluid flushing apparatus according to claim 14 wherein said outer and inner surrounding sidewalls are constructed of a resilient plastic.

20. A fluid flushing apparatus according to claim 14 wherein said outer and inner surrounding sidewalls are constructed of materials selected from the group consisting essentially of acrylonitrile butadiene styrene (ABS), polyethylene, polypropylene, and nitrile rubber materials.
